(19) United States
(12) Patent Application Publication
(10) Pub. No.: US 2026/0066980 A1
(43) Pub. Date: Mar. 5, 2026

(54) WIRELESS DEVICE AND WIRELESS COMMUNICATION SYSTEM

(71) Applicant: Fujikura Ltd., Tokyo (JP)

(72) Inventors: Kazuma Kawahara, Sakura-shi (JP); Yuki Suto, Sakura-shi (JP)

(73) Assignee: Fujikura Ltd., Tokyo (JP)

(21) Appl. No.: 19/312,953

(22) Filed: Aug. 28, 2025

(30) Foreign Application Priority Data
Sep. 4, 2024 (JP) 2024-152256
Jan. 31, 2025 (JP) 2025-015134

(51) Int. Cl. H04B 7/06; H04B 17/318

(52) U.S. Cl. CPC H04B 7/06952; H04B 17/318

(57) ABSTRACT

A wireless device that is one of wireless devices in a first network and sets a reception beam direction with respect to an other wireless device in the first network by using a beam forming function, in which the wireless device is wirelessly connected to the other wireless device in the first network such that a center frequency of the first network is offset to a center frequency of a second network adjacent to the first network, and the reception beam direction in which a state of transmission and reception is improved is set by limiting a beam scanning range of the beam forming function to a predetermined range.

### BACKGROUND OF THE INVENTION

### Field of the Invention The present invention relates to a wireless device and a wireless communication system.

The present application claims priority to Japanese Patent Application No. 2024-152256 filed on Sep. 4, 2024 and Japanese Patent Application No. 2025-015134 filed on Jan. 31, 2025, the contents of which are incorporated herein by reference.

### Description of Related Art

European Patent Application, Publication No. 3982555 and Published Japanese Translation No. 2013-519269 of the PCT International Publication disclose a wireless system that improves a SINR (signal to interference and noise ratio) by using communication signals having overlapping frequency spectra and different center frequencies in each network in a wireless communication environment in which a plurality of networks are present. Such a wireless system is valid in a case where a plurality of networks share the same frequency band, and it is desired to use an efficient frequency band or only a specific frequency to reduce propagation loss due to atmospheric absorption.

### SUMMARY OF THE INVENTION

However, when checking performance of a wireless communication system having a beam forming function regarding the above-described background technology, in a case where an offset (frequency offset) amount of a center frequency is set to about 120 MHz, it is checked that the throughput of a network in which the distance between communication devices is short among a plurality of networks is improved. But, among a plurality of networks, it is checked that normal communication cannot be performed in a network in which a communication distance is long.

That is, since a wireless system of the background technology employs a setting method of a reception direction based on intensity (radio wave intensity) of the reception wave according to a procedure of sector level sweep (SLS), which is a beam direction selection function of the beam forming function in 802.11ad, even when an offset is set to the center frequency, a reception beam is set in a direction of an interference wave when intensity of the received interference wave is relatively strong, and the reception direction is not properly set.

In a wireless communication environment in which a plurality of networks are present, proper setting of a reception direction is an important technical issue.

The present invention is made in view of the above-described circumstances, and an object of the present invention is to provide a wireless device and a wireless communication system capable of properly setting a reception direction in a wireless communication environment in which a plurality of networks are present.

In order to achieve the above-described object, in the present invention, as a first aspect related to a wireless device, the wireless device that is one of wireless devices in a first network and sets a reception beam direction with respect to an other wireless device in the first network by using a beam forming function, and the first network uses a same frequency band as a second network adjacent to the first network, the wireless device is wirelessly connected to the other wireless device in the first network such that a center frequency of the first network is offset to a center frequency of the second network, and the reception beam direction in which a state of transmission and reception is improved is set by limiting a beam scanning range of the beam forming function to a predetermined range.

In the present invention, as a second aspect related to the wireless device, in the first aspect, the beam scanning range may be limited on the basis of the reception beam direction in a case where wireless communication is performed only by the first network.

In the present invention, as a third aspect related to a wireless device, the wireless device is one of wireless devices in a first network and sets a reception beam direction with respect to an other wireless device in the first network by using a beam forming function, and the reception beam direction in which a state of transmission and reception is improved is set based on a noise-dependent parameter.

In the present invention, as a fourth aspect related to the wireless device, in the third aspect, the reception beam direction may be set by automatically controlling the beam forming function by using the noise-dependent parameter.

In the present invention, as a fifth aspect related to the wireless device, in the third aspect, the reception beam direction may be set in a same manner as a transmission beam direction by automatically controlling the beam forming function by using the noise-dependent parameter.

In the present invention, as a sixth aspect related to the wireless device, in the third aspect, a measurement value of the noise-dependent parameter may be acquired after wireless connection to the other wireless device in the first network is established, and the reception beam direction may be set based on the measurement value.

In the present invention, as a seventh aspect related to the wireless device, in the third aspect, a sector value of a transmission sector may be acquired after wireless connection to the other wireless device in the first network is established, and a direction matching the sector value may be set as the reception beam direction.

In the present invention, as an eighth aspect related to the wireless device, in the first aspect, the beam scanning range may be limited to a range in which a half-value width of a transmission beam in the second network is not included.

In the present invention, as a ninth aspect related to the wireless device, in the first aspect, the beam scanning range may be limited to a range in which a 6 dB width of a transmission beam in the second network is not included.

In addition, in the present invention, as an aspect related to a wireless communication system, the wireless device according to any one of the aspects 1 to 9, and the other wireless device in the first network that performs communication with the wireless device may be provided.

According to the present invention, it is possible to provide a wireless device and a wireless communication system capable of properly setting a reception direction in a wireless communication environment in which a plurality of networks are present.

### BRIEF DESCRIPTION OF THE DRAWINGS

FIG. 1 is a block diagram showing the configuration of a wireless communication system according to a first embodiment of the present invention.

FIG. 2 is a flowchart showing a basic operation of the wireless communication system according to the first embodiment of the present invention.

FIG. 3 is a communication sequence diagram showing a beam setting operation of the wireless communication system according to the first embodiment of the present invention.

FIG. 4 is a measurement result showing an interference reduction effect of the wireless communication system according to the first embodiment of the present invention.

FIG. 5 is a communication sequence diagram showing a beam setting operation in a case where wireless devices do not move in the wireless communication system according to the first embodiment of the present invention.

FIG. 6 is a communication sequence diagram showing a connection establishment procedure when beam selection is performed in the first embodiment of the present invention.

FIG. 7 is a communication sequence diagram showing an alignment procedure of a transmission beam in a case where a wireless device is not moved in the first embodiment of the present invention.

FIG. 8 is a flowchart showing a procedure of selecting and reading a beam table suitable for a direction of a communication partner during wireless activation in the first embodiment of the present invention.

FIG. 9 is a block diagram showing the configuration of a wireless communication system according to a second embodiment of the present invention.

FIG. 10 is a block diagram showing the configuration of a wireless communication system according to a third embodiment of the present invention.

FIG. 11 is a characteristic diagram showing an example of directivity of a transmission beam in each of the embodiments of the present invention.

FIG. 12 is an explanatory diagram showing a limitation example of a beam scanning range in a wireless communication system A according to the first embodiment of the present invention.

### DETAILED DESCRIPTION OF THE INVENTION

Hereinafter, embodiments of the present invention will be described with reference to the drawings.

### First Embodiment

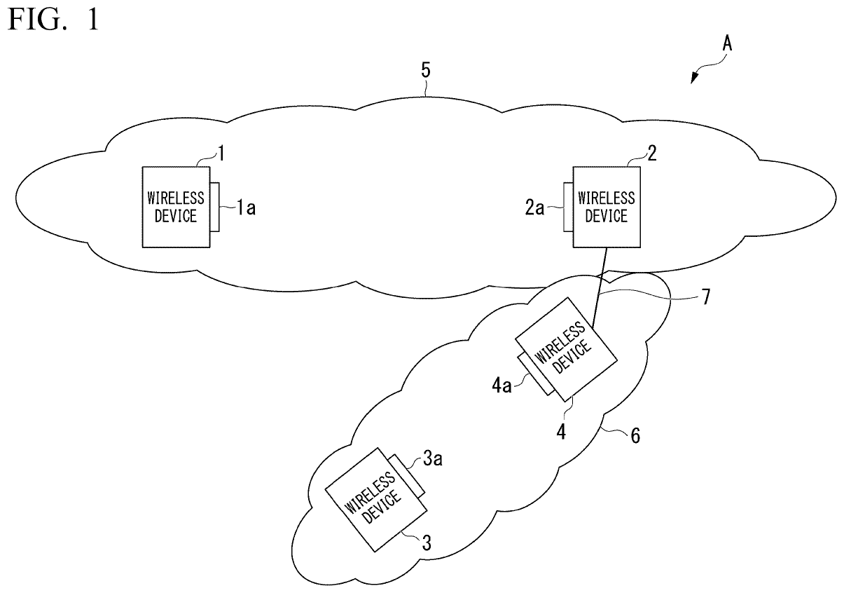

Initially, a first embodiment of the present invention will be described. As shown in FIG. 1, a wireless communication system A according to a first embodiment includes four wireless devices 1 to 4. Among the four wireless devices 1 to 4, a first wireless device 1 and a second wireless device 2 constitute a first network 5, and a third wireless device 3 and a fourth wireless device 4 constitute a second network 6.

Here, in the first embodiment, a wireless communication system A including four wireless devices 1 to 4 and two networks 5 and 6 will be described as an example, but the number of wireless devices is not limited to four, and the number of networks is not limited to two. That is, the present invention can be applied to a wireless communication system including two or more networks.

A unique identifier (SSID: Service Set Identifier) is set to each of the first network 5 and the second network 6, and the first network 5 and the second network 6 perform individual wireless communication. In addition, the first network 5 and the second network 6 use the same frequency band. Further, the first network 5 or the second network 6 performs offsetting of a center frequency. In the first network 5, one of the first wireless device 1 and the second wireless device 2 is an access point (AP) or a PBSS (personal basic service set) control point (PCP), and the other is a station (STA). The first wireless device 1 is the other wireless device that performs wireless communication with the second wireless device 2.

The first wireless device 1 and the second wireless device 2 are provided in a facing state as shown in the drawing. That is, the first wireless device 1 is provided in a facing posture with respect to the second wireless device 2, and the second wireless device 2 is provided in a facing posture with respect to the first wireless device 1. The first wireless device 1 and the second wireless device 2 perform wireless communication using a first identifier (first SSID).

In addition, in the second network 6, one of the third wireless device 3 and the fourth wireless device 4 is an access point (AP) or a PCP, and the other is a station (STA). The third wireless device 3 and the fourth wireless device 4 are provided in a facing state as shown in the drawing.

That is, the third wireless device 3 is provided in a facing posture with respect to the fourth wireless device 4, and the fourth wireless device 4 is provided in a facing posture with respect to the third wireless device 3. The third wireless device 3 and the fourth wireless device 4 perform wireless communication using a second identifier (second SSID) different from the first identifier, in the first network 5.

Among the four wireless devices 1 to 4, the second wireless device 2 and the fourth wireless device 4 are disposed at relatively close positions. The first wireless device 1 constituting the first network 5 together with the second wireless device 2 is disposed at a position facing the second wireless device 2 and at a position relatively far from the second wireless device 2. The third wireless device 3 constituting the second network 6 together with the fourth wireless device 4 is disposed at a position facing the fourth wireless device 4 and at a position relatively far from the fourth wireless device 4.

In addition, each of the four wireless devices 1 to 4 includes each of RF modules 1a to 4a. That is, the first wireless device 1 includes a first RF module 1a, and the second wireless device 2 includes a second RF module 2a. In addition, the third wireless device 3 includes a third RF module 3a, and the fourth wireless device 4 includes a fourth RF module 4a.

The four RF modules 1a to 4a are high-frequency modules capable of setting a transmission beam direction of a transmission wave and a reception beam direction (reception direction) of a reception wave by a beam forming function. The four RF modules 1a to 4a select (designate) one beam sector from a plurality of beam sectors defined in a beam table and set a transmission direction (radiation direction) of a transmission wave and a reception direction of a reception wave within a predetermined range.

That is, the four RF modules 1a to 4a set the reception beam direction by automatically controlling the beam forming function by using the noise-dependent parameter instead of manually setting the reception beam direction. The four RF modules 1a to 4a may be configured to manually set the reception beam direction as necessary.

The first RF module 1a appropriately sets a radiation direction of a transmission wave for the second RF module 2a and a reception direction of a reception wave incident from the second RF module 2a by designating any beam sector from its own beam table (first beam table).

The second RF module 2a appropriately sets a radiation direction of a transmission wave for the first RF module 1a and a reception direction of a reception wave incident from the first RF module 1a by designating any beam sector from its own beam table (second beam table).

The third RF module 3a appropriately sets a radiation direction of a transmission wave for the fourth RF module 4a and a reception direction of a reception wave incident from the fourth RF module 4a by designating any beam sector from its own beam table (third beam table).

The fourth RF module 4a appropriately sets a radiation direction of a transmission wave for the third RF module 3a and a reception direction of a reception wave incident from the third RF module 3a by designating any beam sector from its own beam table (fourth beam table).

Here, the four RF modules 1a to 4a do not set a reception beam direction (reception direction) of a reception wave based on intensity (reception power) of a reception wave as in the background technology, and set the reception beam direction (reception direction) of the reception wave based on a communication parameter (noise-dependent parameter) depending on noise of the reception signal obtained from the reception wave.

The noise-dependent parameter is, for example, a signal to noise ratio (SNR), a bit error rate (BER), a packet error rate (PER), a throughput, or a modulation and coding scheme (MCS). Each of the RF modules 1a to 4a acquires a measurement value of the noise-dependent parameter and selects a beam sector for setting the reception beam direction (reception direction) based on the measurement value.

The noise-dependent parameter is not limited to one. That is, a beam sector for setting the reception beam direction (reception direction) may be selected based on any of a plurality of measurement values such as the signal to noise ratio, the bit error rate, the packet error rate, the throughput, or the MCS described above.

In addition, the four RF modules 1a to 4a set the reception beam direction (reception direction) by using the noise-dependent parameter, and limit a beam scanning range in the beam forming function to a predetermined range. That is, the four wireless devices 1 to 4 limit a selection range of a beam sector to a limited scanning range narrower than the beam scanning range defined in the beam table, and then search for the reception beam direction in which a state of transmission and reception is improved.

The limited scanning range is set on the basis of the reception beam direction in a state in which the wireless communication in the second network 6 is stopped. That is, the beam scanning range is limited on the basis of the reception beam direction in a case where the wireless communication is performed only by the first network 5.

The four wireless devices 1 to 4 reduce interference between the wireless communications of the first network 5 and the wireless communication of the second network 6 by setting the reception beam direction and limiting the beam scanning range using the noise-dependent parameters in the RF modules 1a to 4a.

In addition, the second wireless device 2 in the first network 5 is connected to the fourth wireless device 4 in the second network 6 by a wired communication line 7. The wired communication line 7 is configured by, for example, a combination of a local area network (LAN) cable, a switch, and the like.

The first network 5 and second network 6 form a multi-hop network.

That is, the first network 5 and the second network 6 use the same communication channel, but have a relationship in which frequency spectra of communication signals overlap and center frequencies are frequency offset by a predetermined amount. The first network 5 and the second network 6 frequency-offset the center frequencies at which the frequency spectra overlap, and accordingly, mutual interference of wireless communication is reduced.

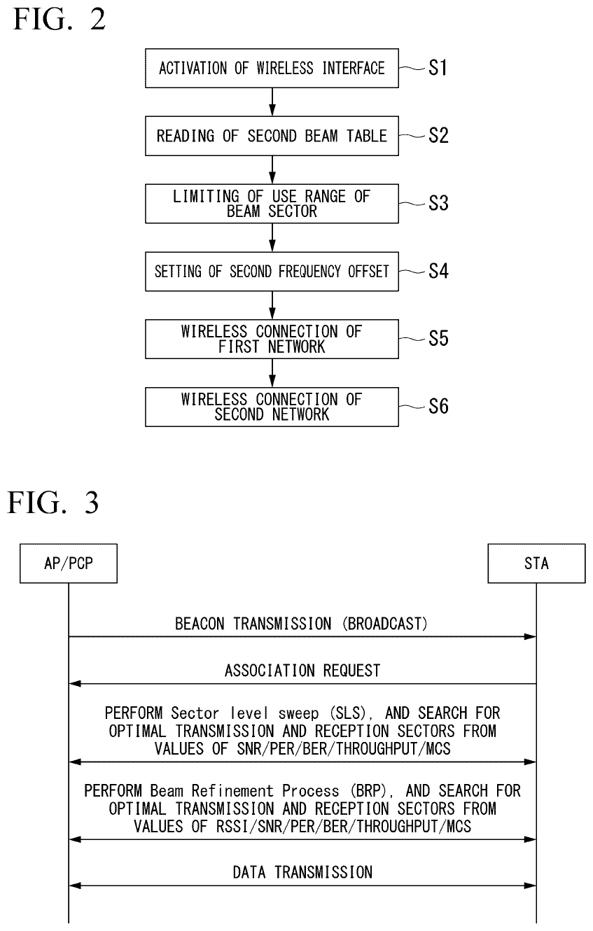

Next, operations and performances of the wireless devices 1 to 4 and the wireless communication system A according to the first embodiment will be described in detail with reference to FIGS. 2 to 8.

Initially, in the wireless communication system A according to the first embodiment, the first wireless device 1 and the second wireless device 2 constitute the first network 5, and the first wireless device 1 faces the second wireless device 2.

In addition, among the third wireless device 3 and the fourth wireless device 4 constituting the second network 6, the third wireless device 3 is located at an angle of 90°or less with respect to the second wireless device 2 constituting the first network 5.

In such a positional relationship of the four wireless devices 1 to 4, in a case where a reception sector (reception direction) of the second RF module 2a in the second wireless device 2 is set based on intensity (radio wave intensity) of a reception wave as in the related art, there is a concern that the reception sector (reception direction) is set to a direction of the third wireless device 3 instead of an original direction of the first wireless device 1.

For example, in a case where intensity (radio wave intensity) of a transmission wave of the third wireless device 3 is greater than intensity (radio wave intensity) of a transmission wave of the first wireless device 1, a reception sector (reception direction) of the second wireless device 2 can be set to a direction of the third wireless device 3 instead of a direction of the first wireless device 1 when the reception sector (reception direction) of the second wireless device 2 is set based on intensity (radio wave intensity) of a reception wave.

In addition, in a case where the distance between the second wireless device 2 and the third wireless device 3 is less than the distance between the second wireless device 2 and the first wireless device 1, the reception sector (reception direction) of the second wireless device 2 can be set to the direction of the third wireless device 3 instead of the direction of the first wireless device 1 when the reception sector (reception direction) of the second wireless device 2 is set based on the intensity (radio wave intensity) of the reception wave.

In response to such a concern, in the wireless communication system A, the first network 5 and the second network 6 perform wireless connection according to a procedure shown in FIG. 2. That is, a wireless interface is activated initially in the four wireless devices 1 to 4 (step S1). Then, when the wireless interface is activated, the second wireless device 2 reads a beam table stored in advance (step S2).

Then, the second wireless device 2 in the first network 5 is limited a use range of a beam sector in the beam table to a range (limit range) stored in advance (step S3).

Then, the third wireless device 3 and the fourth wireless device 4 in the second network 6 set the frequency offset of the communication signal to a predetermined amount (offset amount) stored in advance (step S4).

Through the above-described series of processing steps S1 to S4, the first network 5 and the second network 6 complete preparation for wireless connection. When the processing step S4 is completed, the first wireless device 1 is set as a station (STA) in the first network 5, and the second wireless device 2 is set as an access point (AP) or a PCP. Then, the first wireless device 1 and the second wireless device 2 in the first network 5 perform wireless connection by using a first identifier (first SSID) (step S5).

Meanwhile, in the second network 6, the third wireless device 3 is set as a station (STA), and the fourth wireless device 4 is set as an access point (AP) or a PCP. Then, the third wireless device 3 and the fourth wireless device 4 in the second network 6 perform wireless connection by using a second identifier (second SSID) (step S6).

In addition, the second wireless device 2 (AP/PCP) and the first wireless device 1 (STA) in the first network 5 perform beam setting based on a beam table through a communication sequence shown in FIG. 3.

Initially, the second wireless device 2 (AP/PCP) transmits a beacon to the first wireless device 1 (STA) as a broadcast signal.

The first wireless device 1 (STA) transmits an association request to the second wireless device 2 (AP/PCP) in response to the beacon. Then, the first wireless device 1 (STA) and the second wireless device 2 (AP/PCP) search for beam sectors, in which a state of transmission and reception is improved by sector level sweep (SLS) based on a measurement value of the noise-dependent parameter described above, as the transmission and reception sectors.

Further, the first wireless device 1 (STA) and the second wireless device 2 (AP/PCP) perform a beam refinement process (BRP) based on a measurement value of the noise-dependent parameter to search for beam sectors, in which a state of transmission and reception is improved, as the transmission and reception sectors. Then, the first wireless device 1 (STA) and the second wireless device 2 (AP/PCP) mutually transmit search result data, that is, the transmission and reception sectors (beam sectors).

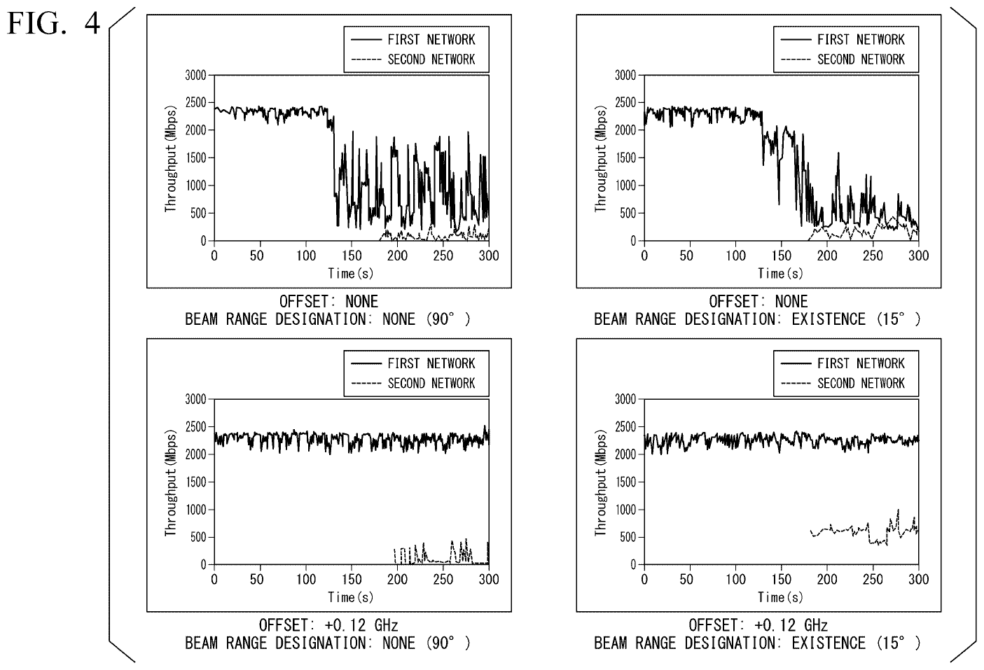

FIG. 4 is a measurement result showing interference reduction effects of the four wireless devices 1 to 4 and the wireless communication system A. In this measurement, a wireless signal having an occupied bandwidth of about 1.8 GHz is used. The measurement result is a value obtained by measuring throughput in a case where frequency offset of the wireless signal in the second network 6 is set to “None”, a case where the frequency offset is set to 0.12 GHz, a case where a beam scanning range of a reception beam is set to normal “90°”, and a case where the beam scanning range is limited to “15°”.

The measurement result shows that it is possible to secure the throughput necessary for performing a normal wireless communication by limiting the beam scanning range of the reception beam to 15°and setting a reception beam direction (reception direction) by using a noise-dependent parameter.

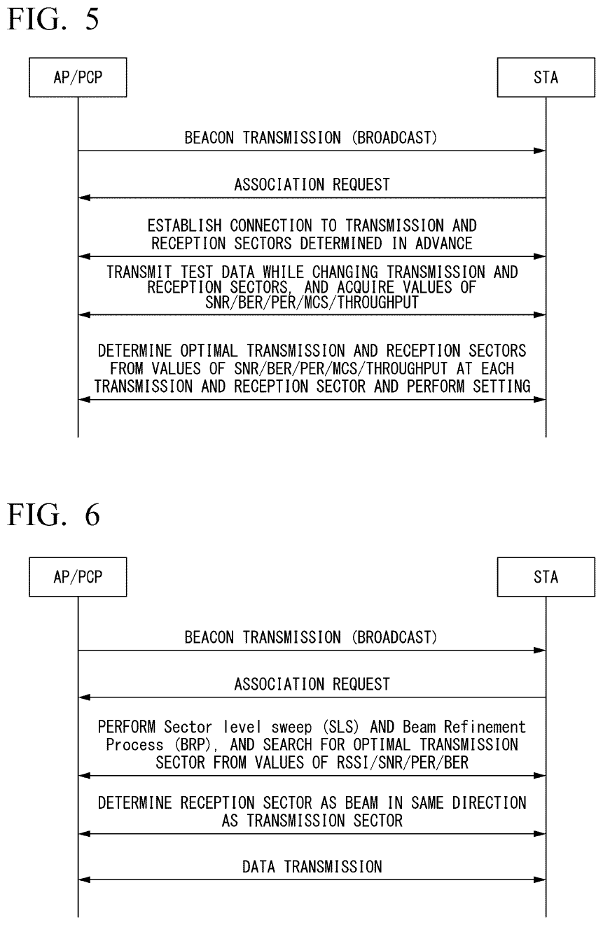

Here, in a case where both the first wireless device 1 (STA) and the second wireless device 2 (AP/PCP) are base stations, the first wireless device 1 and the second wireless device 2 are fixedly disposed, and installation positions do not move. In such a case, beam setting based on the noise-dependent parameter and a beam table is performed by wireless communication shown in FIG. 5.

Initially, the second wireless device 2 (AP/PCP) transmits a beacon to the first wireless device 1 (STA) as a broadcast signal. Then, the first wireless device 1 (STA) transmits an association request to the second wireless device 2 (AP/PCP) in response to the beacon. Then, the first wireless device 1 (STA) and the second wireless device 2 (AP/PCP) establish connection by using transmission and reception sectors set in advance.

Then, the first wireless device 1 (STA) and the second wireless device 2 (AP/PCP) transmit and receive test data while changing the transmission and reception sectors, and acquire a measurement value of the noise-dependent parameter related to the test data of each of the transmission and reception sectors. Then, the first wireless device 1 (STA) and the second wireless device 2 (AP/PCP) finally set a beam sector, in which a state of transmission and reception is improved, based on the measurement value of the noise-dependent parameter in each of the transmission and reception sectors, as the transmission and reception sectors.

Instead of a setting method of the transmission and reception sectors, only the transmission sector may be optimally set based on the measurement value of the noise-dependent parameter. FIG. 6 is a communication sequence in a case where a transmission sector is optimally set based on the measurement value of the noise-dependent parameter and then the reception sector is determined. In this case, the second wireless device 2 (AP/PCP) transmits the beacon to the first wireless device 1 (STA) as a broadcast signal.

The first wireless device 1 (STA) transmits an association request to the second wireless device 2 (AP/PCP) in response to the beacon. Then, the first wireless device 1 (STA) and the second wireless device 2 (AP/PCP) perform sector level sweep (SLS) and a beam refinement process (BRP) based on a measurement value of a noise-dependent parameter to search for a transmission sector (beam sector).

Then, the first wireless device 1 (STA) and the second wireless device 2 (AP/PCP) determine (set) a sector value of the reception sector (beam sector) to be the same value (the same direction) as a sector value of the transmission sector (beam sector). Then, the first wireless device 1 (STA) and the second wireless device 2 (AP/PCP) mutually transmit the sector values of the reception sectors (beam sectors).

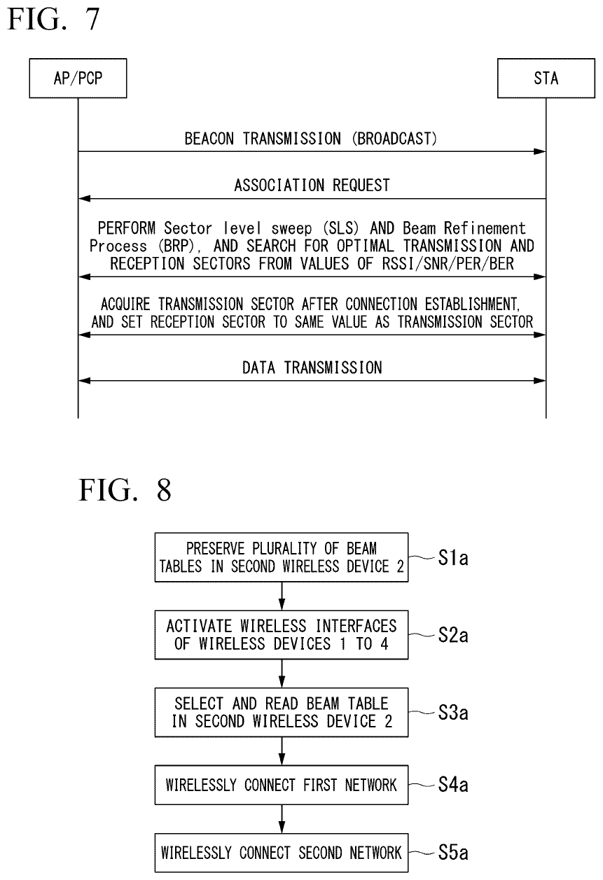

FIG. 7 is a communication sequence in a case where a reception sector is optimally set based on a measurement value of a noise-dependent parameter in a case where both the first wireless device 1 (STA) and the second wireless device 2 (AP/PCP) are base stations. In this case, the second wireless device 2 (AP/PCP) transmits the beacon to the first wireless device 1 (STA) as a broadcast signal.

Then, the first wireless device 1 (STA) transmits an association request to the second wireless device 2 (AP/PCP) in response to the beacon. Then, the first wireless device 1 (STA) and the second wireless device 2 (AP/PCP) perform sector level sweep (SLS) and a beam refinement process (BRP) based on a measurement value of a noise-dependent parameter to search for a transmission sector (beam sector).

Then, the first wireless device 1 (STA) and the second wireless device 2 (AP/PCP) mutually acquire a sector value of a transmission sector (beam sector) after the connection is established, and set the sector value of the reception sector (beam sector) to the same value (the same direction) as a sector value of a transmission sector (beam sector). Then, the first wireless device 1 (STA) and the second wireless device 2 (AP/PCP) mutually transmit the sector values of the reception sectors (beam sectors).

Further, in a wireless connection procedure shown in FIG. 2, a use range of a beam sector is limited after a beam table is read, but a beam table for scanning only a specific direction can be prepared separately, and the beam table suitable for a direction of a communication partner may be selected and read when wireless activation is performed.

In this case, as shown in FIG. 8, a plurality of beam tables are preserved initially in the second wireless device 2 (step S1a). Then, wireless interfaces of the four wireless devices 1 to 4 are activated (step S2a). Then, the second wireless device 2 selects and reads a beam table suitable for a direction of the first wireless device 1 which is a communication partner among the plurality of beam tables (step S3a).

Then, in the first network 5, the first wireless device 1 is set as a station (STA), and the second wireless device 2 is set as an access point (AP) or a PCP. Then, the first wireless device 1 and the second wireless device 2 perform wireless connection by using a first identifier (first SSID) (step S4a).

In addition, in the second network 6, the third wireless device 3 is set as a station (STA), and the fourth wireless device 4 is set as an access point (AP) or a PCP. Then, the third wireless device 3 and the fourth wireless device 4 perform wireless connection by using a second identifier (second SSID) (step S5a).

The second wireless device 2 according to the first embodiment is a wireless device that configures the first network 5 together with the first wireless device 1 (the other wireless device) and sets a reception beam direction (reception direction) with respect to the first wireless device 1 (the other wireless device) by a beam forming function, and sets a reception beam direction in which a state of transmission and reception are improved by limiting a beam scanning range of the beam forming function to a limited scanning range (predetermined range).

Here, the first network 5 includes wireless devices such as the first wireless device 1 and the second wireless device 2. In the first network 5, one of the wireless devices sets a reception beam direction (reception direction) with respect to the other wireless device by a beam forming function. That is, the wireless device that is one of wireless devices in a first network 5 sets a reception beam direction in which a state of transmission and reception are improved by limiting a beam scanning range of the beam forming function to a limited scanning range (predetermined range)

“Limiting a beam scanning range to a predetermined range” refers to limiting the beam scanning range (for example, ±30°in a horizontal direction) from a beam scanning range (for example, ±45°in the horizontal direction) originally possessed by a wireless device. For Example, the beam scanning range is limited by limiting a use range of the beam sector in the beam table, to a predetermined range. In addition, “state of transmission and reception is improved” means a state in which a beam sector of transmission and reception is in an optimal position or a state in which communication is possible.

According to the first embodiment, since the beam scanning range is limited to the limited scanning range (predetermined range) in the second wireless device 2, it is possible to suppress or prevent a reception beam direction (reception direction) from being set to a direction of the third wireless device 3 in the second network 6 instead of a direction of the first wireless device 1 (the other wireless device in the first network 5).

Therefore, according to the first embodiment, it is possible to provide the second wireless device 2 that can set the reception beam direction (reception direction) to a proper direction, that is, to a direction of the first wireless device 1 (the other wireless device in the first network 5) in a wireless communication environment in which a plurality of networks such as the first network 5 and the second network 6 are present.

In addition, in the second wireless device 2 according to the first embodiment, the beam scanning range is limited on the basis of a reception beam direction in a case where wireless communication is performed only through the first network 5. According to the first embodiment, it is possible to set the reception beam direction (reception direction) to a more proper direction.

In addition, the second wireless device 2 according to the first embodiment is a wireless device that configures the first network 5 together with the first wireless device 1 (the other wireless device in the first network 5) and sets a reception beam direction (reception direction) for the first wireless device 1 (the other wireless device in the first network 5) by a beam forming function, and sets a reception beam direction, in which a state of transmission and reception is improved, based on a noise-dependent parameter.

According to the first embodiment, a reception beam direction (reception direction) of a reception wave is set based on the noise-dependent parameter related to the reception signal instead of intensity (reception power) of a reception wave in the related art. Therefore, it is possible to suppress or prevent a reception beam direction (reception direction) from being set to a direction of the third wireless device 3 in the second network 6 instead of a direction of the first wireless device 1 (the other wireless device in the first network 5).

Therefore, according to the first embodiment, it is possible to provide the second wireless device 2 in which a reception beam direction (reception direction) can be set to a proper direction in a wireless communication environment in which a plurality of networks including the first network 5 and the second network 6 are present, as in a case where a beam scanning range is limited to the limited scanning range (the predetermined range).

In addition, in the wireless system A according to the first embodiment, a reception beam direction is set by automatically controlling a beam forming function by using a noise-dependent parameter. According to the first embodiment, it is possible to set the reception beam direction (reception direction) more properly and in a shorter amount of time.

In addition, in the wireless system A according to the first embodiment, a reception beam direction (reception direction) is set in the same manner as a transmission beam direction (transmission direction) by automatically controlling a beam forming function by using the noise-dependent parameter. According to the first embodiment, a transmission beam direction (transmission direction) and a reception beam direction (reception direction) can be set properly and in a short amount of time.

In addition, in the wireless system A according to the first embodiment, a measurement value of a noise-dependent parameter is acquired after wireless connection with the first wireless device 1 (the other wireless device in the first network 5) is established, and a reception beam direction is set based on the measurement value. According to the first embodiment, the measurement value of the noise-dependent parameter is acquired after the wireless connection with the first wireless device 1 (the other wireless device in the first network 5) is established, accordingly, the reception beam direction (reception direction) can be set more properly.

In addition, in the wireless system A according to the first embodiment, a sector value of a transmission sector is acquired after wireless connection with the first wireless device 1 (the other wireless device in the first network 5) is established, and a direction matching the sector value is set as the reception beam direction. According to the first embodiment, the reception beam direction is set to match a transmission beam direction after the wireless connection with the first wireless device 1 (the other wireless device in the first network 5) is established, and accordingly, the reception beam direction (reception direction) and the transmission beam direction can be properly set.

In addition, the wireless system A according to the first embodiment includes the second wireless device 2 and the first wireless device 1 (the other wireless device in the first network 5) that performs a wireless communication with the second wireless device 2. According to the first embodiment, it is possible to provide the system A that can set a reception beam direction (reception direction) to a proper direction in a wireless communication environment in which a plurality of networks including the first network 5 and the second network 6 are present.

### Second Embodiment

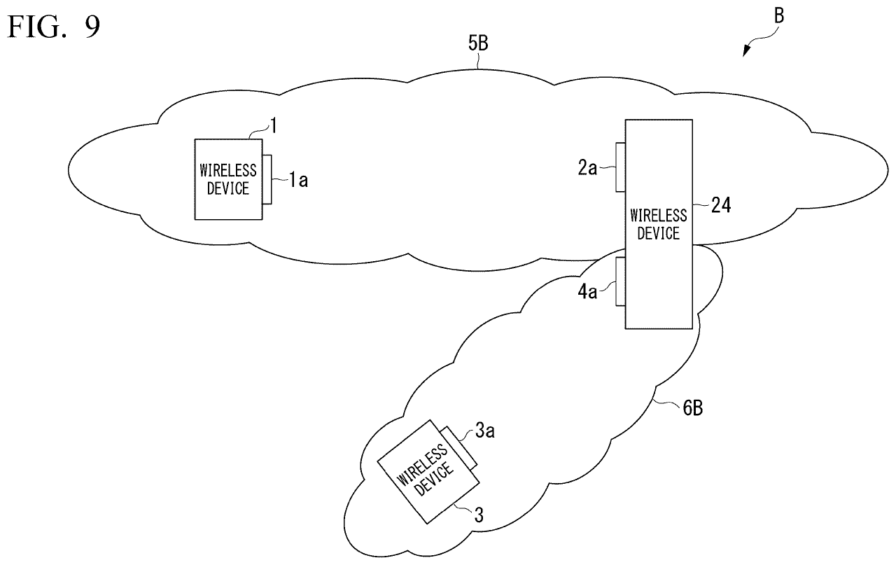

Subsequently, a second embodiment of the present invention will be described with reference to FIG. 9. As shown in FIG. 9, a wireless communication system B according to a second embodiment is a system in which the second wireless device 2 and the fourth wireless device 4 are integrated in the wireless communication system A according to the first embodiment. That is, the wireless communication system B according to the second embodiment includes a composite wireless device 24 facing the first wireless device 1, instead of the second wireless device 2 and the fourth wireless device 4.

The composite wireless device 24 constitutes a first network 5B together with the first wireless device 1, and also constitutes a second network 6B together with the third wireless device 3. In addition, as shown in FIG. 9, the composite wireless device 24 includes a second RF module 2a and a fourth RF module 4a.

The composite wireless device 24 performs wireless connection with the first RF module 1a in which a first identifier (first SSID) is used, by using the second RF module 2a. In addition, the composite wireless device 24 performs wireless connection with the third RF module 3a in which a second identifier (second SSID) is used, by using the fourth RF module 4a.

With the composite wireless device 24 and the wireless communication system B according to the second embodiment, in the same manner as the second wireless device 2 and the wireless communication system A according to the first embodiment, a reception beam direction (reception direction) is set by using a noise-dependent parameter in addition to limiting a beam scanning range of a reception beam, and accordingly, it is possible to properly set the reception direction in a wireless communication environment in which the two networks 5 and 6 are present.

### Third Embodiment

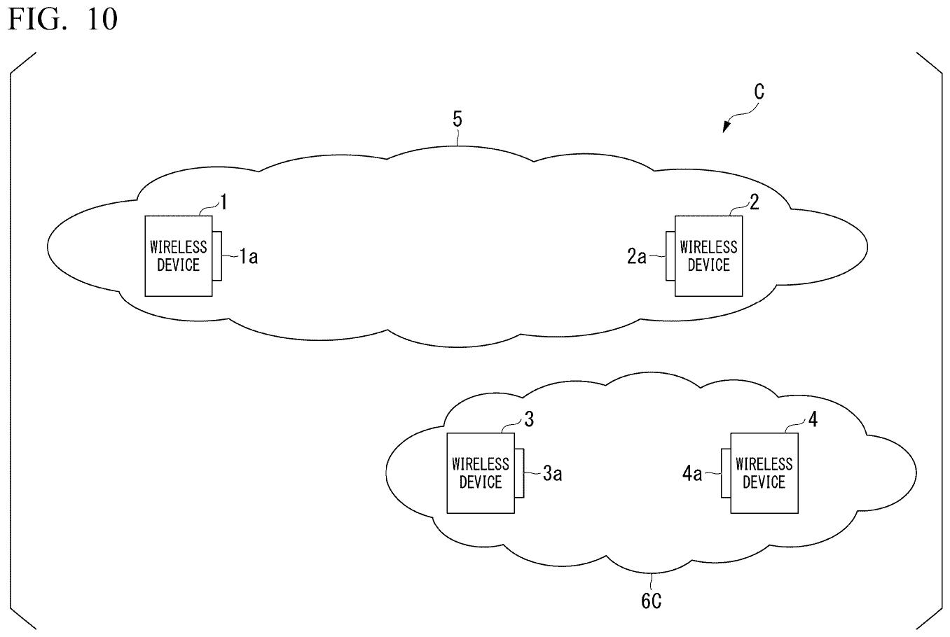

Subsequently, a third embodiment of the present invention will be described with reference to FIG. 10. As shown in FIG. 10, a wireless communication system C according to the third embodiment includes a second network 6C in which a facing direction between the third wireless device 3 and the fourth wireless device 4 is the same as the facing direction of the first network 5.

That is, the facing direction between the third wireless device 3 and the fourth wireless device 4 in the second network 6C is the same as the facing direction between the first wireless device 1 and the second wireless device 2 in the first network 5.

In addition, the second network 6C is disposed to be separated from the first network 5 by a predetermined distance as shown.

In the wireless communication system C, the facing direction between the first wireless device 1 and the second wireless device 2 in the first network 5 is the same as the facing direction between the third wireless device 3 and the fourth wireless device 4 in the second network 6C, and accordingly, there is a high possibility that a reception sector (reception direction) is not properly set as compared with the wireless communication system A according to the first embodiment and the wireless communication system B according to the second embodiment.

However, with the wireless communication system C according to the third embodiment, in addition to limiting a beam scanning range of a reception beam, a reception beam direction (reception direction) is set by using a noise-dependent parameter, and accordingly, it is possible to properly set the reception directions of the second wireless device 2 and the fourth wireless device 4 in a wireless communication environment in which the two networks 5 and 6C are present.

### Additional Matters

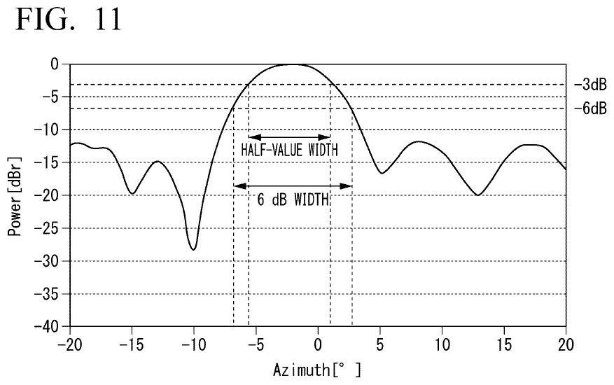

FIG. 11 is a characteristic diagram showing an example of directivity of a transmission beam. As shown in FIG. 11, the transmission beam has a predetermined half-value width and a 6 dB width greater than the half-value width. The half-value width is a beam angle range until decreases to 3 dB from the maximum value, and the 6 dB width is a beam angle range until decreases to 6 dB from the maximum value.

Although a beam scanning range also depends on the distance between the wireless device 3 and the wireless device 4 and an angle between a facing direction of the wireless device 1 and the wireless device 2 and a facing direction of the wireless device 3 and the wireless device 4, it is preferable that the beam scanning range in the respective embodiments descried above is limited to a range that does not include a half-value width of a transmission beam that is an interference wave. In addition, it is more preferable that the beam scanning range is limited to a range that does not include a 6 dB width of a transmission beam that is an interference wave.

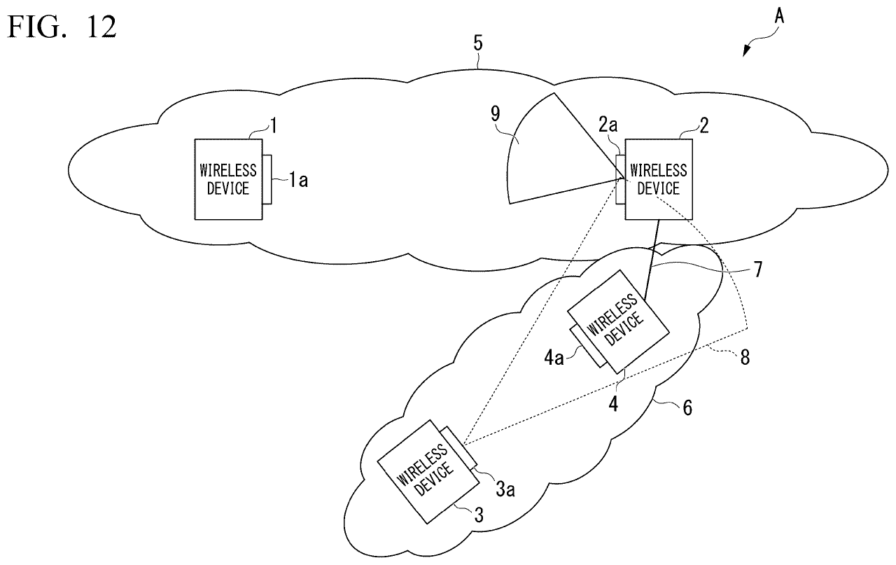

FIG. 12 is an explanatory diagram showing a limitation example of a beam scanning range in the wireless communication system A according to the first embodiment. In FIG. 12, a beam scanning range 9 of the wireless device 2 is limited not to include a half-value width range 8 of a transmission beam (interference wave) radiated from the wireless device 3 to the wireless device 4 such that the wireless device 2 is not affected by the transmission beam transmitted from the wireless device 3, which is an interference source, to the wireless device 4.

The present invention is not limited to the embodiments described above, and for example, the following modification examples are considered.

(1) In each embodiment described above, a wireless communication environment in which two networks are present is described, but the present invention is not limited thereto. That is, the number of a plurality of networks in the present invention may be any number as long as the number is two or more.

(2) In each embodiment described above, in addition to limiting a beam scanning range in a beam forming function to a limited scanning range (predetermined range), a reception beam direction (reception direction) is set by using a noise-dependent parameter instead of intensity (reception intensity) of a reception wave. However, the present invention is not limited thereto.

It is more preferable to set a reception beam direction (reception direction) by using a noise-dependent parameter in addition to limiting a beam scanning range of a reception beam, but either one of limiting the beam scanning range of the reception beam or setting the reception beam direction (reception direction) by using the noise-dependent parameter may be adopted according to a positional relationship or the number of a plurality of networks.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A wireless device that is one of wireless devices in a first network and sets a reception beam direction with respect to an other wireless device in the first network by using a beam forming function,
wherein the first network uses a same frequency band as a second network adjacent to the first network,
the wireless device is wirelessly connected to the other wireless device in the first network such that a center frequency of the first network is offset to a center frequency of the second network, and
the reception beam direction in which a state of transmission and reception is improved is set by limiting a beam scanning range of the beam forming function to a predetermined range.

2. The wireless device according to claim 1,
wherein the beam scanning range is limited on the basis of the reception beam direction in a case where wireless communication is performed only by the first network.

3. A wireless device that is one of wireless devices in a first network and sets a reception beam direction with respect to an other wireless device in the first network by using a beam forming function,
wherein the reception beam direction in which a state of transmission and reception is improved is set based on a noise-dependent parameter.

4. The wireless device according to claim 3,
wherein the reception beam direction is set by automatically controlling the beam forming function by using the noise-dependent parameter.

5. The wireless device according to claim 3,
wherein the reception beam direction is set in a same manner as a transmission beam direction by automatically controlling the beam forming function by using the noise-dependent parameter.

6. The wireless device according to claim 3,
wherein a measurement value of the noise-dependent parameter is acquired after wireless connection to the other wireless device in the first network is established, and the reception beam direction is set based on the measurement value.

7. The wireless device according to claim 3,
wherein a sector value of a transmission sector is acquired after wireless connection to the other wireless device in the first network is established, and a direction matching the sector value is set as the reception beam direction.

8. A wireless communication system comprising:
the wireless device according to claim 1; and
the other wireless device in the first network that performs wireless communication with the wireless device.

9. The wireless device according to claim 1,
wherein the beam scanning range is limited to a range in which a half-value width of a transmission beam in the second network is not included.

10. The wireless device according to claim 1,
wherein the beam scanning range is limited to a range in which a 6 dB width of a transmission beam in the second network is not included.

11. A wireless communication system comprising:
the wireless device according to claim 3; and
the other wireless device in the first network that performs wireless communication with the wireless device.
